(19) United States
(12) Patent Application Publication
(10) Pub. No.: US 2021/0011358 A1
(43) Pub. Date: Jan. 14, 2021

(54) CONTROL METHOD AND DEVICE, GIMBAL, UNMANNED AERIAL VEHICLE, AND COMPUTER-READABLE STORAGE MEDIUM

(71) Applicant: SZ DJI TECHNOLOGY CO., LTD., Shenzhen (CN)

(72) Inventors: Chao WENG, Shenzhen (CN); Xiangyu CHEN, Shenzhen (CN); Yucheng LIU, Shenzhen (CN)

(21) Appl. No.: 17/033,364

(22) Filed: Sep. 25, 2020

Related U.S. Application Data
(63) Continuation of application No. PCT/CN2018/080719, filed on Mar. 27, 2018.

(51) Int. Cl. G03B 17/56; G05D 1/00; G03B 15/00

(52) U.S. Cl. CPC G03B 17/561; B64C 39/024; G03B 15/006; G05D 1/0094

(57) ABSTRACT

A control method for controlling a gimbal system includes controlling a first gimbal of the gimbal system to rotate by a first angle and controlling a second gimbal of the gimbal system to rotate by a second angle, so that a signal input/output range of a first load supported by the first gimbal and a signal input/output range of a second load supported by the second gimbal at least partially overlap.

### CROSS-REFERENCE TO RELATED APPLICATION

This application is a continuation of International Application No. PCT/CN2018/080719, filed Mar. 27, 2018, the entire content of which is incorporated herein by reference.

### TECHNICAL FIELD

The present disclosure relates to consumer electronic products, and in particular to a control method, a control device, a gimbal system, an unmanned aerial vehicle (UAV), and a non-volatile computer-readable storage medium.

### BACKGROUND

Gimbal is a supporting device for mounting, fixing, and stabilizing electronic devices such as cameras, video cameras, sensors, fill lights, etc., which can assist the electronic devices to work well. However, when the number of electronic devices is large and all the electronic devices are mounted at the gimbal at the same time, on the one hand, the mechanical load of the gimbal is heavy, and on the other hand, the control load of the gimbal is heavy since each electronic device needs to be controlled by manipulating the gimbal. As a result, the life of the gimbal is greatly shortened.

### SUMMARY

In accordance with the disclosure, there is provided a control method for controlling a gimbal system including controlling a first gimbal of the gimbal system to rotate by a first angle and controlling a second gimbal of the gimbal system to rotate by a second angle, so that a signal input/output range of a first load supported by the first gimbal and a signal input/output range of a second load supported by the second gimbal at least partially overlap.

Also in accordance with the disclosure, there is provided a control device including a processor configured to control a first gimbal of a gimbal system to rotate by a first angle and control a second gimbal of the gimbal system to rotate by a second angle, so that a signal input/output range of a first load supported by the first gimbal and a signal input/output range of a second load supported by the second gimbal at least partially overlap.

Also in accordance with the disclosure, there is provided a gimbal system including a first gimbal configured to support a first load, a second gimbal configure to support a second load, and a processor configured to: control the first gimbal to rotate by a first angle and control the second gimbal to rotate by a second angle so that a signal input/output range of the first load and a signal input/output range of the second load at least partially overlap.

### BRIEF DESCRIPTION OF THE DRAWINGS

The above and/or additional aspects and advantages of the present disclosure will become apparent and easily understood from the description of the embodiments with reference to the accompanying drawings.

FIG. 1 is a schematic flowchart of a control method according to an embodiment of the disclosure.

FIG. 2 is a schematic structural diagram of an unmanned aerial vehicle (UAV) according to an embodiment of the disclosure.

FIG. 3 is a schematic structural diagram of a UAV according to another embodiment of the disclosure.

FIGS. 4-6 are schematic diagrams showing application scenes of the control method according to some embodiments of the disclosure.

FIG. 7 is a schematic flowchart of a control method according to another embodiment of the disclosure.

FIGS. 8-10 are schematic diagrams showing application scenes of the control method according to some other embodiments of the disclosure.

FIGS. 11-13 are schematic flowcharts of control methods according to some other embodiments of the disclosure.

FIG. 14 is a schematic diagram showing an application scene of a control method according to an embodiment of the disclosure.

FIGS. 15 and 16 are schematic flowcharts of control methods according to some other embodiments of the disclosure.

### DETAILED DESCRIPTION OF THE EMBODIMENTS

The embodiments of the present disclosure are described in detail below. Examples of the embodiments are shown in the accompanying drawings, in which the same or similar reference numerals indicate the same or similar elements or elements having the same or similar functions. The embodiments described below with reference to the accompanying drawings are exemplary, are only used to explain the present disclosure, and are not limiting the present disclosure.

The schematic diagrams provided by the embodiments of the present disclosure only take a movable platform including two loads and two gimbals corresponding to the two loads as examples, and do not limit the movable platform described in the embodiments of the present disclosure. The movable platform described in the embodiments of the present disclosure may include at least two loads, and at least two gimbals corresponding to the at least two loads. The movable platform may include two loads and two gimbals corresponding to the two loads, or may include more than two loads and two gimbals, for example, including four loads and four gimbals corresponding to the four loads.

In the embodiments of the present disclosure, the methods and devices described below are applied to the movable platform described in the embodiments of the present disclosure. The movable platform refers to a movable object including, for example, an aircraft 1000, a car, or a robot, etc. In the embodiments of the present disclosure, the aircraft 1000 being the movable platform is taken as an example for explanation. That is to say, the methods and devices described below are applied to the aircraft 1000 including a first gimbal 10, a second gimbal 20, a first load 30, and a second load 40. For the application of the method and device described below to a UAV including more than two gimbals and two loads, reference may be made to some specific implementation manners applied to a UAV including two gimbals and two loads.

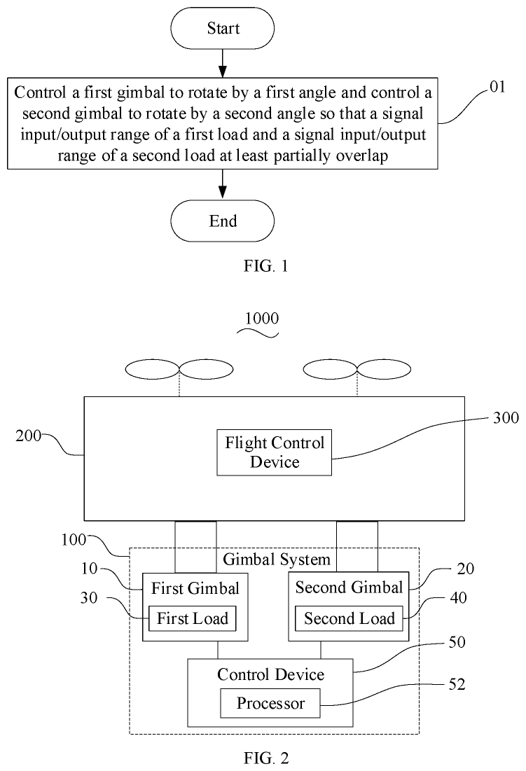

As shown in FIGS. 1 and 2, an embodiment of the present disclosure provides a control method that can be applied to a gimbal system 100. The gimbal system 100 includes the first gimbal 10 and the second gimbal 20. The first gimbal 10 is used to support the first load 30, and the second gimbal 20 is used to support the second load 40.

As shown in FIG. 1, at 01, the first gimbal 10 is controlled to rotate by a first angle F1, and the second gimbal 20 is controlled to rotate by a second angle F2, so that a signal input/output range of the first load 30 and a signal input/output range of the second load 40 at least partially overlap.

As shown in FIG. 2, a control device 50 is further provided according to an embodiment of the present disclosure. The control method according to the embodiments of the present disclosure can be implemented by the control device 50 of the embodiments of the present disclosure. The control device 50 is applied to the gimbal system 100. The gimbal system 100 includes the first gimbal 10 and the second gimbal 20. The first gimbal 10 is used to support the first load 30, and the second gimbal 20 is used to support the second load 40. The control device 50 includes a processor 52 for controlling the first gimbal 10 to rotate by the first angle F1 and controlling the second gimbal 20 to rotate by the second angle F2, so that the signal input/output range of the first load 30 and the signal input/output range of the second load 40 at least partially overlap. That is to say, the process of 01 may be implemented by the processor 52.

The first gimbal 10 may be a single-axis gimbal, a two-axis gimbal, a three-axis gimbal, etc. Correspondingly, the second gimbal 20 may also be a single-axis gimbal, a two-axis gimbal, a three-axis gimbal etc. When both the first gimbal 10 and the second gimbal 20 are three-axis gimbals, the first angle can be any one or more of a yaw angle, a roll angle, and a pitch angle, and the second angle can also be any one or more of the yaw angle, the roll angle, and the pitch angle. In some embodiments, the first angle is the same type as the second angle. For example, when the first angle is the yaw angle, the second angle is also the yaw angle, or when the first angle is the roll angle, the second angle is also the roll angle, or when the first angle is the pitch angle, the second angle is also the pitch angle, or when the first angle is the combination of the yaw angle and the roll angle, the second angle is also the combination of yaw angle and roll angle, or when the first angle is the combination of the yaw angle, the roll angle, and the pitch angle, the second angle is also the combination of the yaw angle, the roll angle, and the pitch angle. The first angle can also be other combinations, as long as the first angle and the second angle are of the same type, which will not be described here.

Through the follow rotation of the second gimbal 20 relative to the first gimbal 10, working results of the first load 30 and the second load 40 can satisfy a preset condition, that is, the working result of the first load 30 and the working result of the second load 40 are complementary to each other, or the working result of the second load 40 bumps up the working result of the first load 30. In some embodiments, the signal input/output range of the first load 30 and the signal input/output range of the second load 40 at least partially overlap. For example, the signal input range of the first load 30 overlaps the signal input range of the second load 40, or the signal input range of the first load 30 overlaps the signal output range of the second load 40, or the signal output range of the first load 30 overlaps the signal input range of the second load 40, or the signal output range of the first load 30 overlaps the signal output range of the second load 40. The signal input/output range of the first load 30 and the signal input/output range of the second load 40 may depend on the types, such as function types, of the first load 30 and the second load 40.

The gimbal has a function of balancing and stabilizing a camera, which can assist the camera to obtain a better shooting effect. However, in a dark environment such as a night or a cloudy day, no matter how good the balance and stabilization effect of the gimbal is, because the imaging effect of the visible light photographing device in the dark environment is poor, the quality of the image captured by the camera is low.

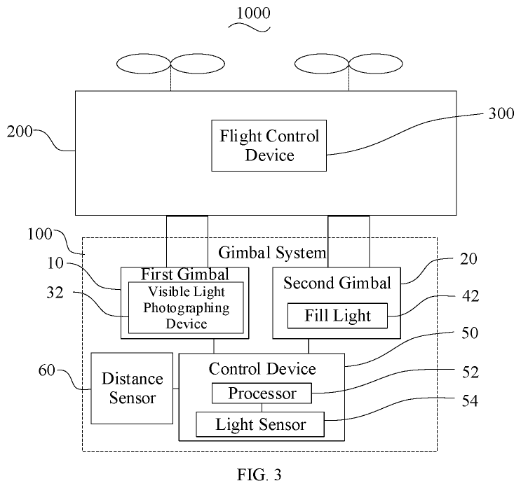

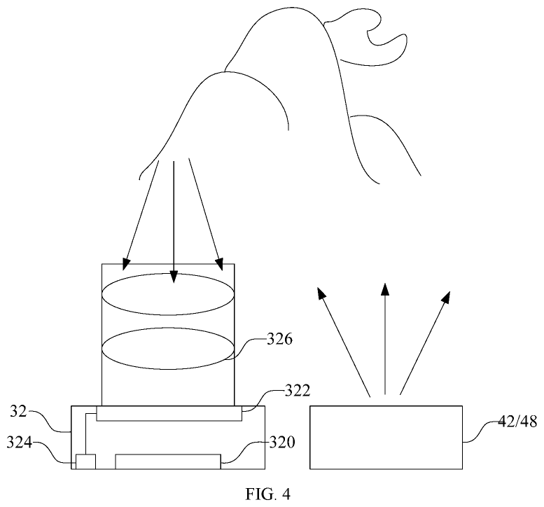

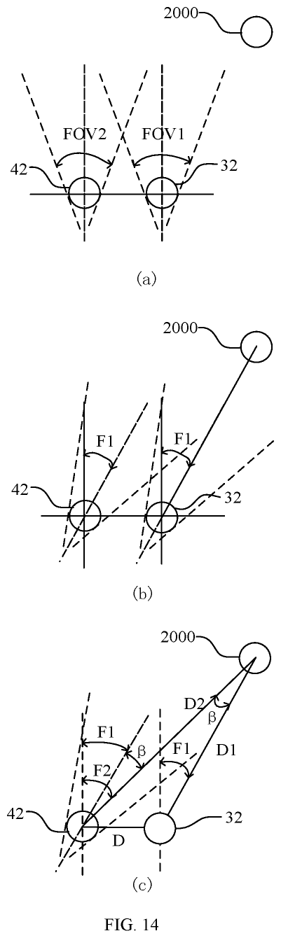

As shown in FIG. 3, in order to improve the imaging effect of the visible light photographing device in the dark environment, the first load 30 is a visible light photographing device 32 and the second load 40 is a fill light 42. The signal input/output range of the visible light photographing device 32 refers to a field of view of the visible light photographing device 32. The field of view of the visible light photographing device 32 may refer to a capture range of the visible light photographing device 32 to capture light. The signal input/output range of the fill light 42 refers to the field of view of the fill light 42 (also referred to as a fill range of the fill light 42, i.e., a range that the light emitted from the fill light 42 can fill). The field of view of the fill light 42 may refer to the coverage of the light emitted from the fill light 42. The working result of the visible light photographing device 32 is assisted by the working result of the fill light 42. For example, in a low-brightness shooting environment such as a night or a cloudy day, the brightness of the image captured by the visible light photographing device 32 is low, and the entire picture is very dim and fuzzy. If the light is enhanced by the fill light 42, the image captured by the visible light photographing device 32 is clear and bright. During the working process, the field of view FOV2 (shown in part (a) of FIG. 14) obtained when the fill light 42 fills the light (performs light filling) is the working result of the fill light 42, and the field of view FOV1 (shown in FIG. 14) obtained when the visible light photographing device 32 captures an image is the working result of the visible light photographing device 32. As long as the field of view FOV2 of the fill light 42 and the field of view FOV1 of the visible light photographing device 32 (shown in FIG. 14) at least partially overlap (that is, the working results of the two meet a preset condition), the final scene image captured is a clear and bright image. Furthermore, the working result of the visible light photographing device 32 and the working result of the fill light 42 meeting the preset condition may also be that a target shooting object 2000 (shown in FIG. 14) is within the field of view FOV2 when the fill light 42 fills the light, and the target shooting object 2000 is within the field of view FOV1 when the visible light photographing device 32 captures an image. Furthermore, the working result of the visible light photographing device 32 and the working result of the fill light 42 meeting the preset condition may also be that the target shooting object 2000 is at the fill center (center of light filling) of the field of view FOV2 when the fill light 42 fills the light, and the target shooting object 2000 is at the view center of the field of view FOV1 when the visible light photographing device 32 captures an image. In some embodiments, the working result of the visible light photographing device 32 and the working result of the fill light 42 meeting the preset condition may also be that the field of view FOV2 obtained when the fill light 42 fills the light covers the field of view FOV1 obtained when the visible light photographing device 32 captures an image.

As shown in FIG. 4, the visible light photographing device 32 includes an image sensor 320, an infrared cut-off filter 322, a switch 324, and a lens 326. The infrared cut-off filter 322 is located between the image sensor 320 and the lens 326 for blocking most of the infrared light and allowing the visible light to pass through. The switch 324 can remove the infrared cut-off filter 322 from the light-receiving optical path of the visible light photographing device 32 after receiving a control signal from the processor 52. The fill light 42 includes at least one of an infrared fill light or a visible light fill light. For example, at a first scenario, the fill light 42 is a visible light fill light, such as a searchlight. When the visible light photographing device 32 shoots in a low-brightness environment, the visible light fill light can be turned on, and the visible light emitted by the visible light fill light illuminates the shooting scene and is reflected into the visible light photographing device 32 by objects in the scene (mountains shown in FIG. 4), and then the visible light passes through the lens 326 and the infrared cut-off filter 322 and reaches the image sensor 320. The visible light photographing device 32 can obtain a clearer and brighter visible light image. At a second scenario, the fill light 42 is an infrared fill light. When the visible light photographing device 32 shoots in a low brightness environment, the infrared fill light can be turned on, and the processor 52 controls the switch 324 to remove the infrared cut-off filter 322 from the light-receiving optical path of the visible light photographing device 32. The infrared light emitted by the infrared fill light illuminates the shooting scene and is reflected into the visible light photographing device 32 by objects in the scene. The infrared light passes through the lens 326 and directly reaches the image sensor 320. The visible light photographing device 32 can obtain a clearer and brighter infrared image.

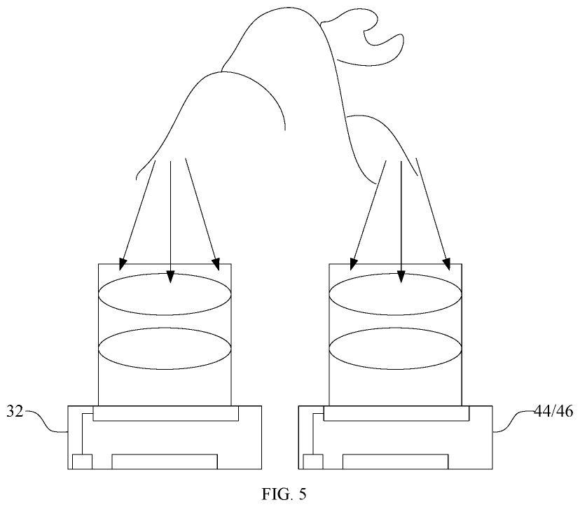

The first load 30 is not limited to the visible light photographing device 32, and the second load 40 is not limited to the fill light 42. As shown in FIG. 5, the first load 30 is the visible light photographing device 32, and the second load 40 is also a visible light photographing device 44. The visible light photographing device 32 and the visible light photographing device 44 form a binocular vision system, which can be used for distance measurement. The measured distance can be used for obstacle avoidance, flying around, mapping and surveying, etc. The signal input/output range of the visible light photographing device 32 refers to a field of view of the visible light photographing device 32. The field of view of the visible light photographing device 32 may refer to a capture range of the visible light photographing device 32 to capture light. The signal input/output range of the visible light photographing device 44 refers to a field of view of the visible light photographing device 44. The field of view of the visible light photographing device 44 may refer to a capture range of the visible light photographing device 44 to capture light. During the working process, the field of view obtained when the visible light photographing device 32 captures an image is the working result of the visible light photographing device 32, and the field of view obtained when the visible light photographing device 44 captures an image is the working result of the visible light photographing device 44. As long as the field of view of the visible light photographing device 44 and the field of view of the visible light photographing device 32 at least partially overlap (that is, the signal input/output ranges of both at least partially overlap), a distance can be measured. Furthermore, the working result of the visible light photographing device 32 and the working result of the visible light photographing device 44 meeting a preset condition may also be that a target shooting object is within the field of view when the visible light photographing device 44 captures an image, and the target shooting object is within the field of view when the visible light photographing device 32 captures an image. Furthermore, the working result of the visible light photographing device 32 and the working result of the visible light photographing device 44 meeting the preset condition may also be that the target shooting object is at the view center of the field of view when the visible light photographing device 44 captures an image, and the target shooting object is at the view center of the field of view when the visible light photographing device 32 captures an image.

In some other embodiments, as shown in FIG. 5, the first load 30 is a visible light photographing device 32, and the second load 40 is an infrared light photographing device 46. The visible light photographing device 32 and the infrared light photographing device 46 form a depth camera system, which can be used to detect depth information of the scene. According to the depth information, a depth map can be formed. The depth map can be merged with the visible light image to form a three-dimensional image, which can be applied to three-dimensional mapping. The signal input/output range of the visible light photographing device 32 refers to a field of view of the visible light photographing device 32. The field of view of the visible light photographing device 32 may refer to a capture range of the visible light photographing device 32 to capture light. The signal input/output range of the infrared light photographing device 46 refers to a field of view of the infrared light photographing device 46. The field of view of the infrared light photographing device 46 may refer to a capture range of the infrared light photographing device 46 to capture light. During the working process, the field of view obtained when the visible light photographing device 32 captures an image is the working result of the visible light photographing device 32, and the field of view obtained when the infrared light photographing device 46 captures an image is the working result of the infrared light photographing device 46. As long as the field of view of the infrared light photographing device 46 and the field of view of the visible light photographing device 32 at least partially overlap (that is, the signal input/output ranges of both at least partially overlap), a depth map can be obtained and a three-dimensional image can be fused. Furthermore, the working result of the visible light photographing device 32 and the working result of the infrared light photographing device 46 meeting a preset condition may also be that a target shooting object is within the field of view when the infrared light photographing device 46 captures an image, and the target shooting object is within the field of view when the visible light photographing device 32 captures an image. Furthermore, the working result of the visible light photographing device 32 and the working result of the infrared light photographing device 46 meeting the preset condition may also be that the target shooting object is at the view center of the field of view when the infrared light photographing device 46 captures an image, and the target shooting object is at the view center of the field of view when the visible light photographing device 32 captures an image.

In some embodiments, as shown in FIG. 4, the first load 30 is a visible light photographing device 32, and the second load 40 is a sprinkler 48. The visible light photographing device 32 and the sprinkler 48 form a sprinkler system, which can be applied to agricultural irrigation or garden maintenance. The signal input/output range of the visible light photographing device 32 refers to a field of view of the visible light photographing device 32. The field of view of the visible light photographing device 32 may refer to a capture range of the visible light photographing device 32 to capture light. The signal input/output range of the sprinkler 48 refers to a sprinkling range of the sprinkler 48, and the sprinkling range of the sprinkler 48 may refer to a coverage of the water sprayed by the sprinkler 48. During the working process, the field of view obtained when the visible light photographing device 32 captures an image is the working result of the visible light photographing device 32, and the sprinkling range obtained when the sprinkler 48 sprinkles is the working result of the sprinkler 48. As long as the sprinkling range of the sprinkler 48 and the field of view of the visible light photographing device 32 at least partially overlap (that is, the signal input/output ranges of both at least partially overlap), the water can be sprayed more accurately. Furthermore, the working result of the visible light photographing device 32 and the working result of the sprinkler 48 meeting a preset condition may also be that a target shooting object is within the field of view when the visible light photographing device 32 captures an image, and a target sprinkling object is within the sprinkling range when the sprinkler 48 sprinkles. Furthermore, the working result of the visible light photographing device 32 and the working result of the sprinkler 48 meeting the preset condition may also be that the target shooting object is at the view center of the field of view when the visible light photographing device 32 captures an image, and the target sprinkling object is at the sprinkling center of the sprinkling range when the sprinkler 48 sprinkles. The target shooting object and the target sprinkling object may be the same object.

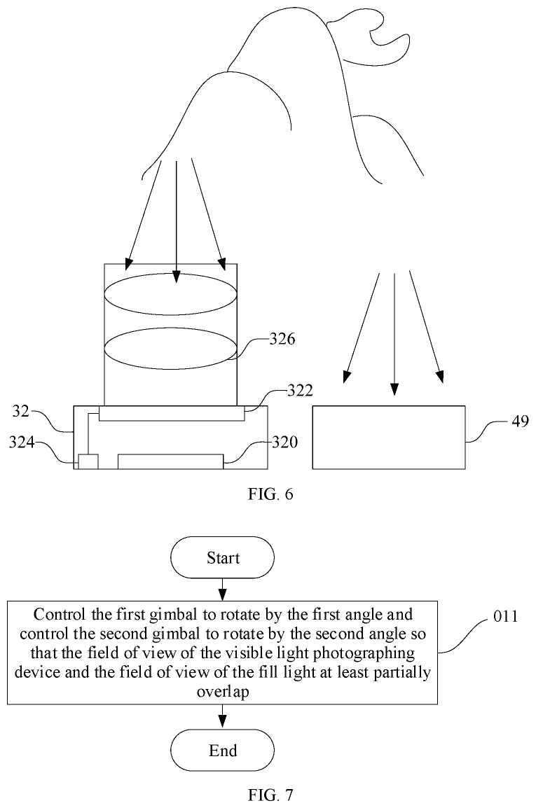

In some embodiments, as shown in FIG. 6, the first load 30 is a visible light photographing device 32, and the second load 40 is a detector 49. The visible light photographing device 32 and the detector 49 form a detection system, which can be applied to exploration, surveying, etc. For example, the detector 49 receives data detected by sensors near the underground gas layer to determine whether the gas supply of the gas layer is normal. The signal input/output range of the visible light photographing device 32 refers to a field of view of the visible light photographing device 32, and the field of view of the visible light photographing device 32 may refer to a capture range of the visible light photographing device 32 to capture light. The signal input/output range of the detector 49 refers to a signal coverage of the detector 49 and the signal coverage of the detector 49 may refer to a working range where the detector 49 can receive and send signals with the object to be measured. The signal may be an electrical signal, an acoustic signal, an optical signal, a temperature value, a humidity value, a pressure value, etc. During the working process, the field of view obtained when the visible light photographing device 32 captures an image is the working result of the visible light photographing device 32, and the signal coverage range obtained when the detector 49 detects is the working result of the detector 49. As long as the signal coverage of the detector 49 and the field of view of the visible light photographing device 32 at least partially overlap (that is, the signal input/output ranges of both at least partially overlap), the collected data from the collector of the ground terminal can be received. Furthermore, the working result of the visible light photographing device 32 and the working result of the detector 49 meeting a preset condition may also be that a target shooting object is within the field of view when the visible light photographing device 32 captures an image, and a target detecting object is within the signal coverage when the detector 49 detects. Furthermore, the working result of the visible light photographing device 32 and the working result of the detector 49 meeting the preset condition may also be that the target shooting object is at the view center of the field of view when the visible light photographing device 32 captures an image, and the target detecting object is at the center of the signal coverage when the detector 49 detects. The target shooting object and the target detecting object may be the same object.

In some other embodiments, for example, both the first load 30 and the second load 40 are visible light photographing devices 32 and rotate through the cooperation of the first gimbal 10 and the second gimbal 20. One visible light photographing device 32 captures a close-range image of an object, and another visible light photographing device 32 captures a long-range image of the same object. Then the signal input/output ranges of the first load 30 and the second load 40 at least partially overlapping may be that the two field of views at least partially overlap to obtain the close-range image and the long-range image at the same time to provide users with more image information. For another example, the first load 30 and the second load 40 are both fill lights 42, and rotate through the cooperation of the first gimbal 10 and the second gimbal 20. The focal lengths of the two fill lights 42 are different, then the signal input/output ranges of the first load 30 and the second load 40 at least partially overlapping may be that the field of views at least partially overlap. Therefore, the field of view, the fill light intensity, and the fill light distance of the fill lights 42 are enhanced.

The relationship among the first load 30, the second load 40, and their working results can be set as needed and is not limited here.

According to the control method and the control device 50 provided by the embodiments of the present disclosure, the first load 30 is supported through the first gimbal 10, and the second load 40 is supported through the second gimbal 20. The first gimbal 10 and the second gimbal 20 are controlled to rotate to make the signal input/output ranges of the first load 30 and the second load 40 at least partially overlap. Avoiding the first load 30 and the second load 40 being carried on the same gimbal at the same time, on the one hand, reduces the mechanical load of a single gimbal, and on the other hand, reduces the control load of a single gimbal by avoiding controlling the first load 30 and the second load 40 through controlling the same gimbal, thereby extending the life of each gimbal. Furthermore, disposing the first load 30 and the second load 40 at the first gimbal 10 and the gimbal 20, respectively, can realize not only controlling the first gimbal 10 separately to control the first load 30, controlling the second gimbal 20 separately to control the second load 40, but also controlling the first gimbal 10 and the second gimbal 20 at the same time to realize the mutual assistance of the first load 30 and the second load 40, and is more practical.

To simplify the description, as an example, in the following control method and the control device 50, the first load 30 is the visible light photographing device 32 and the second load 40 is the fill light 42. The control method and the control device 50 with the first load 30 and the second load 40 being other components are similar and are not described separately in this disclosure.

As shown in FIG. 7, in some embodiments, in order to make a signal input/output range of a first load 30 and a signal input/output range of a second load 40 at least partially overlap, controlling a first gimbal 10 to rotate by a first angle F1 and controlling a second gimbal 20 to rotate by a second angle F2 (process 01 in FIG. 1) includes controlling the first gimbal 10 to rotate by the first angle F1 and controlling the second gimbal 20 to rotate by the second angle F2 so that a field of view FOV1 of a visible light photographing device 32 and a field of view FOV2 of a fill light 42 at least partially overlap (011).

Referring to FIG. 3, the processor 52 is configured to control the first gimbal 10 to rotate by the first angle F1, and to control the second gimbal 20 to rotate by the second angle F2, so that the field of view FOV1 of the visible light photographing device 32 and the field of view FOV2 of the fill light 42 at least partially overlap. That is, the process of 011 can be executed by the processor 52.

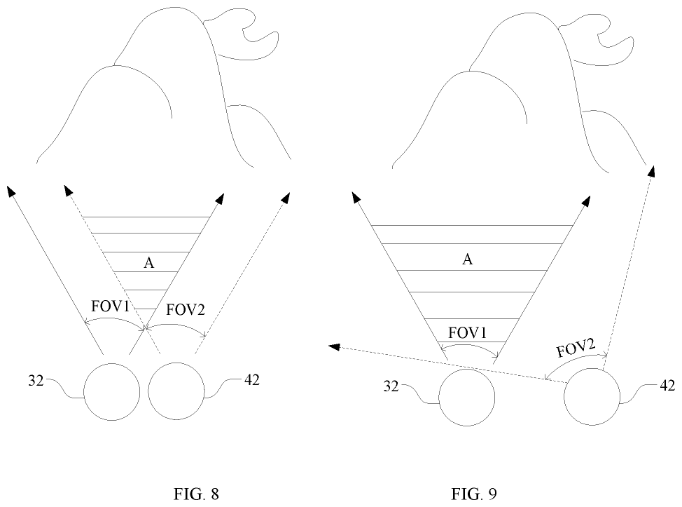

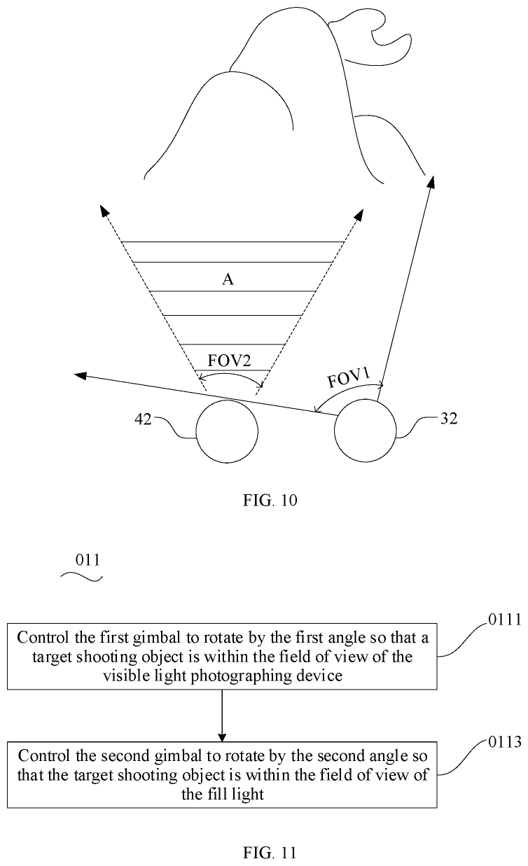

The field of view FOV1 of the visible light photographing device 32 at least partially overlapping the field of view FOV2 of the fill light 42 includes the following scenarios. As shown in FIG. 8, the field of view FOV1 of the visible light photographing device 32 partially overlaps the field of view FOV2 of the fill light 42, and the overlapping area A (shaded portion) is between the FOV1 and FOV2. As shown in FIG. 9, the field of view FOV1 of the visible light photographing device 32 partially overlaps the field of view FOV2 of the fill light 42, and the field of view FOV2 of the fill light 42 completely covers the field of view FOV1 of the visible light photographing device 32. As shown in FIG. 10, the field of view FOV1 of the visible light photographing device 32 partially overlaps the field of view FOV2 of the fill light 42, and the field of view FOV1 of the visible light photographing device 32 completely covers the field of view FOV2 of the fill light 42. When the distance between the visible light photographing device 32 and the fill light 42 is sufficiently small (can be regarded as installed at the same position), the field of view FOV1 of the visible light photographing device 32 and the field of view FOV2 of the fill light 42 can be regarded as completely overlapping. In any of the above scenarios, when the shooting environment is a low-brightness environment, the fill light 42 can fill light for the scene image captured by the visible light photographing device 32.

In some embodiments, when the field of view FOV2 of the fill light 42 completely covers the field of view FOV1 of the visible light photographing device 32, the entire field of view of the visible light photographing device 32 can be filled with light, which is suitable for a scenario with no target shooting object or with a target shooting object occupying a large part of the field of view FOV1 of the visible light photographing device 32 (such as shooting landscape images, geographic images, etc.), and provides a better light fill effect.

As shown in FIGS. 11 and 14, in some embodiments, controlling the first gimbal 10 to rotate by the first angle F1 and controlling the second gimbal 20 to rotate by the second angle F2 so that the field of view FOV1 of the visible light photographing device 32 and the field of view FOV2 of the fill light 42 at least partially overlap (011 in FIG. 7) includes controlling the first gimbal 10 to rotate by the first angle F1 so that a target shooting object 2000 is within the field of view FOV1 of the visible light photographing device 32 (0111 in FIG. 11) and controlling the second gimbal 20 to rotate by the second angle F2 so that the target shooting object 2000 is within the field of view FOV2 of the fill light 42 (0113 in FIG. 11).

Referring to FIG. 3, the processor 52 is configured to control the first gimbal 10 to rotate by the first angle F1 so that the target shooting object 2000 is within the field of view FOV1 of the visible light photographing device 32, and to control the second gimbal 20 to rotate by the second angle F2 so that the target shooting object 2000 is within the field of view FOV2 of the fill light 42. That is, the processes of 0111 and 0113 can be executed by the processor 52.

If the fill light 42 fills light over the entire scene, the fill light may have no focus. The light from the fill light 42 obtained by the objects in the scene is more scattered, and the filling effect on the target shooting object 2000 that the user wants to shoot is not good. The control device 50 of the embodiments can, through the processor 52, control the first gimbal 10 to rotate by the first angle F1 and the second gimbal 20 to rotate by the second angle F2 according to the target shooting object 2000 selected by a user from a preview screen when the visible light photographing device 32 displays the preview screen, so that the target shooting object 2000 is not only within the field of view FOV1 of the visible light photographing device 32 but also within the field of view FOV2 of the fill light 42. In this way, the target shooting object 2000 can be used as a focus for filling light instead of filling light on objects in the entire scene, therefore, a better filling effect is ensured for the important target shooting object 2000.

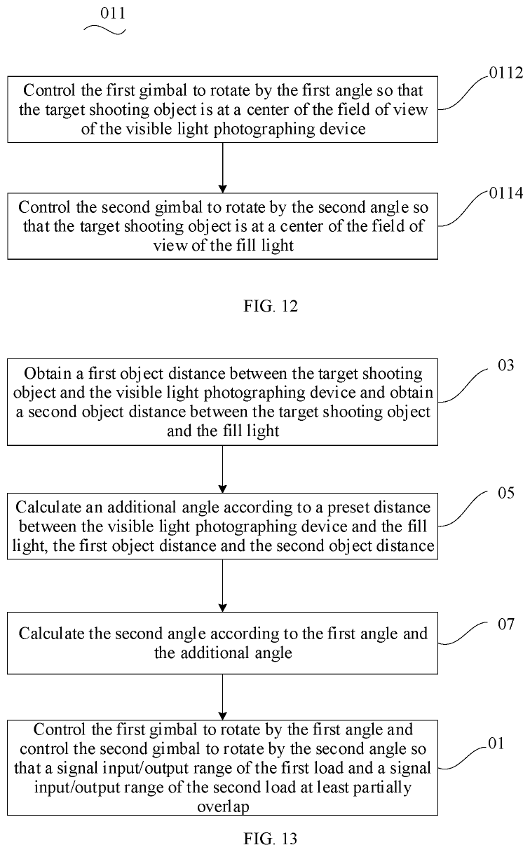

As shown in FIGS. 12 and 14, in some embodiments, controlling the first gimbal 10 to rotate by the first angle F1 so that the target shooting object 2000 is within the field of view FOV1 of the visible light photographing device 32 (0111 in FIG. 11) includes controlling the first gimbal 10 to rotate by the first angle F1 so that the target shooting object 2000 is at the center of the field of view of the visible light photographing device 32 (0112 in FIG. 12).

Controlling the second gimbal 20 to rotate by the second angle F2 so that the target shooting object 2000 is within the field of view FOV2 of the fill light 42 (0113 in FIG. 11) includes controlling the second gimbal 20 to rotate by the second angle F2 so that the target shooting object 2000 is at the center of the field of view of the fill light 42 (0114 in FIG. 12).

Referring to FIG. 3, the processor 52 is configured to control the first gimbal 10 to rotate by the first angle F1 so that the target shooting object 2000 is at the center of the field of view of the visible light photographing device 32, and to control the second gimbal 20 to rotate by the second angle F2 so that the target shooting object 2000 is at the center of the field of view of the fill light 42. That is, the processes of 0112 and 0114 may be executed by the processor 52.

The control device 50 of the embodiments not only uses the processor 52 to control the rotation of the first gimbal 10 and the second gimbal 20 so that the fill light 42 focuses on filling light on the target shooting object 2000 when the visible light photographing device 32 captures an image, but also makes the target shooting object 2000 at both the center of the field of view of the visible light photographing device 32 and the center of the field of view of the fill light 42. The target shooting object 2000 being at the center of the field of view of the visible light photographing device 32 is beneficial for achieving a quick and accurate focusing on the target shooting object 2000. The target shooting object 2000 being at center of the field of view of the fill light 42 makes the fill light more concentrated, further improves the effect of filling light, and is also beneficial for observing a large range of the surrounding scenes of the target shooting object 2000, so as to be suitable for some specific scenarios, such as reconnaissance.

In some embodiments, the first angle F1 is the same as the second angle F2. Since the distance between the first gimbal 10 and the second gimbal 20 is generally much smaller than the distance between the first gimbal 10 and the target shooting object 2000, and is also much smaller than the distance between the second gimbal 20 and the target shooting object 2000, the installation positions of the first gimbal 10 and the second gimbal 20 can be regarded as the same. If the field of view of the visible light photographing device 32 and the field of view of the fill light 42 at least partially overlap, when the first gimbal 10 and the second gimbal 20 rotate at the same angle, the field of view of the visible light photographing device 32 and the field of view of the fill light 42 are considered to be at least partially overlapping, or even remain completely overlapping, so that the fill light 42 can provide good fill light for the scene to be captured by the visible light photographing device 32 and a better light fill effect is achieved.

Referring to FIG. 3, controlling the first gimbal 10 to rotate by the first angle F1 and controlling the second gimbal 20 to rotate by the second angle F2 may be implemented according to a same control instruction, and the first angle F1 and the second angle F2 are obtained by input. In some embodiments, a gimbal system 100 is applied to a UAV 1000, that is, the visible light photographing device 32 and the fill light 42 are mounted at the UAV 1000 through the gimbal system 100. During the flight of the UAV 1000, a flight control device 300 at the UAV 1000 receives a control instruction, which is input by a user through a remote control of a ground terminal, and the single control instruction includes a first angle F1 and a second angle F2. That is, the user inputs the instruction to control the first gimbal 10 to rotate by the first angle F1 and control the second gimbal 20 to rotate by the second angle F2 through the remote control. This instruction is received by the flight control device 300 and forwarded to the processor 52. According to the instruction, the processor 52 is configured to control the first gimbal 10 to rotate by the first angle F1 and control the second gimbal 20 to rotate by the second angle F2 at the same time. Therefore, a synchronized rotation of the first gimbal 10 and the second gimbal 20 is completed, and a synchronized control of the visible light photographing device 32 and the fill light 42 is realized. In some embodiments, after the single instruction is received by the flight control device 300, according to the instruction, the processor 52 may be configured to control the first gimbal 10 to rotate by the first angle F1 first, and then control the second gimbal 20 to rotate by the second angle F2 to complete a time-division rotation of the first gimbal 10 and the second gimbal 20 and realize a time-division control of the visible light photographing device 32 and the fill light 42. In one example, the first angle F1 and the second angle F2 are the same, that is, the user sends the same control instruction, and the first gimbal 10 and the second gimbal 20 rotate synchronously at the same angle, or, the user sends the same control instruction that includes both the first angle F1 and the second angle F2, and the first gimbal 10 and the gimbal 20 rotate by the same angle in time-division.

Referring to FIG. 3, in some embodiments, controlling the first gimbal 10 to rotate by the first angle F1 and controlling the second gimbal 20 to rotate by the second angle F2 may be implemented according to a same control instruction, and the first angle F1 is obtained by input, and the second angle F2 is calculated according to the first angle F1. In some embodiments, the flight control device 300 at the UAV 1000 receives a control instruction that is input by a user through the remote control of the ground terminal, and the control instruction includes the first angle F1. That is, the user inputs the instruction to control the first gimbal 10 to rotate by the first angle F1. After this single instruction is received by the flight control device 300, according to the first angle F1, the flight control device 300 calculates the second angle F2 that the second gimbal 20 needs to rotate (or, the single command is received by the flight control device 300 and forwarded to the processor 52, and according to the first angle F1, the processor 52 calculates the second angle F2 that the second gimbal 20 needs to rotate). According to the instruction, the processor 52 is configured to control the first gimbal 10 to rotate by the first angle F1 and control the second gimbal 20 to rotate by the second angle F2 at the same time. Therefore, a synchronized rotation of the first gimbal 10 and the second gimbal 20 is completed, and a synchronized control of the visible light photographing device 32 and the fill light 42 is realized. In some embodiments, after the single instruction is received by the flight control device 300, according to the first angle F1, the flight control device 300 calculates the second angle F2 that the second gimbal 20 needs to rotate (or, the single command is received by the flight control device 300 and forwarded to the processor 52, and according to the first angle F1, the processor 52 calculates the second angle F2 that the second gimbal 20 needs to rotate). According to the instruction, the processor 52 may be configured to control the first gimbal 10 to rotate by the first angle F1 first, and then control the second gimbal 20 to rotate by the second angle F2 to complete a time-division rotation of the first gimbal 10 and the second gimbal 20 and realize a time-division control of the visible light photographing device 32 and the fill light 42. In one example, the first angle F1 and the second angle F2 are the same, that is, the user sends the same control instruction, and the first gimbal 10 and the second gimbal 20 rotate synchronously at the same angle, or, the user sends the same control instruction that only includes the first angle F1, and the first gimbal 10 and the gimbal 20 rotate by the same angle in time-division.

Referring to FIG. 3, controlling the first gimbal 10 to rotate by the first angle F1 and controlling the second gimbal 20 to rotate by the second angle F2 may be implemented according to two control instructions, and the first angle F1 and the second angle F2 are obtained by input. In some embodiments, the flight control device 300 at the UAV 1000 receives two control instructions, which are input by the user through the remote control of the ground terminal, and one control instruction includes the first angle F1 and the other control instruction include the second angle F2. That is, the user inputs the first instruction to control the first gimbal 10 to rotate by the first angle F1 and the second instruction to control the second gimbal 20 to rotate by the second angle F2 through the remote control. The two instruction are received by the flight control device 300 and forwarded to the processor 52. The processor 52 is configured to control the first gimbal 10 to rotate by the first angle F1 according to the first control instruction, and control the second gimbal 20 to rotate by the second angle F2 at the same time according to the second control instruction. Therefore, a synchronized rotation of the first gimbal 10 and the second gimbal 20 is completed, and a synchronized control of the visible light photographing device 32 and the fill light 42 is realized. In some embodiments, after the two instructions are received by the flight control device 300, the processor 52 may be configured to control the first gimbal 10 to rotate by the first angle F1 first according to the first control instruction, and then control the second gimbal 20 to rotate by the second angle F2 according to the second control instruction to complete a time-division rotation of the first gimbal 10 and the second gimbal 20 and realize a time-division control of the visible light photographing device 32 and the fill light 42. In one example, the first angle F1 and the second angle F2 are the same, that is, the user sends two control instructions, and the first gimbal 10 and the second gimbal 20 rotate synchronously at the same angle, or, the user sends two control instructions, and the first gimbal 10 and the gimbal 20 rotate by the same angle in time-division.

Referring to FIGS. 3, 13 and 14, in some embodiments, the control method further includes obtaining a first object distance D1 between the target shooting object 2000 and the visible light photographing device 32 and a second object distance D2 between the target shooting object 2000 and the fill light 42 (03), calculating an additional angle β according to a preset distance D between the visible light photographing device 32 and the fill light 42, the first object distance D1, and the second object distance D2 (05), and calculating the second angle F2 according to the first angle F1 and the additional angle β (at 07).

The gimbal system 100 further includes a distance sensor 60 for detecting the first object distance D1 between the target shooting object 2000 and the visible light photographing device 32, and detecting the second object distance D2 between the target shooting object 2000 and the fill light 42. The processor 52 is connected to the distance sensor 60 and reads the data in the distance sensor 60, that is, the processor 52 is configured to obtain the first object distance D1 between the target shooting object 2000 and the visible light photographing device 32 and obtain the second object distance D2 between the target shooting object 2000 and the fill light 42, calculate the additional angle β according to the preset distance D between the visible light photographing device 32 and the fill light 42, the first object distance D1 and the second object distance D2, and calculate the second angle F2 according to the first angle F1 and the additional angle β. That is, the processes of 03, 05 and 07 can be executed by the processor 52.

The distance sensor 60 may be a laser rangefinder or a binocular vision system as described above. In this way, the measurement accuracy is high, which is beneficial to precise focusing to improve the light fill effect. In one example, the second angle F2 is equal to the sum of the first angle F1 and the additional angle β. When the fill light 42 rotates by the second angle F2, that is, by an angle of F1+β, the target shooting object 2000 locates at the center of the field of view of the fill light 42, and the light on the target shooting object 2000 is the strongest and the light fill effect is good. In some embodiments, the gimbal system 100 is applied to the UAV 1000, that is, the visible light photographing device 32 and the fill light 42 are mounted at the UAV 1000 through the gimbal system 100. During the flight of the UAV 1000, at an initial state, the visible light photographing device 32 and the fill light 42 are usually directed forward, and the first gimbal 10 and the second gimbal 20 are at a zero position. After the user confirms the target shooting object 2000 through the remote control on the ground terminal and inputs a single control instruction including the first angle F1, the flight control device 300 receives the single control instruction, and the flight control device 300 calculates the second angle F2 that the second gimbal 20 needs to rotate according to the first angle F1 (or the single instruction is received by the flight control device 300 and forwarded to the processor 52, and the processor 52 calculates the second angle F2 that the second gimbal 20 needs to rotate according to the first angle F1). According to the instruction, the processor 52 controls the first gimbal 10 to rotate by the first angle F1 and control the second gimbal 20 to rotate by the second angle F2 at the same time. Therefore, a synchronized rotation of the first gimbal 10 and the second gimbal 20 is completed, and a synchronized control of the visible light photographing device 32 and the fill light 42 is realized. In some embodiments, after the single instruction is received by the flight control device 300, according to the first angle F1, the flight control device 300 calculates the second angle F2 that the second gimbal 20 needs to rotate (or, the single command is received by the flight control device 300 and forwarded to the processor 52, and according to the first angle F1, the processor 52 calculates the second angle F2 that the second gimbal 20 needs to rotate). According to the instruction, the processor 52 may control the first gimbal 10 to rotate by the first angle F1 first, and then control the second gimbal 20 to rotate by the second angle F2 to complete a time-division rotation of the first gimbal 10 and the second gimbal 20 and realize a time-division control of the visible light photographing device 32 and the fill light 42. The second angle F2 satisfies the following relationship F2=F1+β. In some other embodiments, the second angle F2 may also satisfy the following relationship F2>F1+β or F2<F1+β, as long as the field of view of the visible light photographing device 32 and the field of view of the fill light 42 at least partially overlap after the first gimbal 10 rotates by the first angle F1 and the second gimbal 20 rotates by the second angle F2.

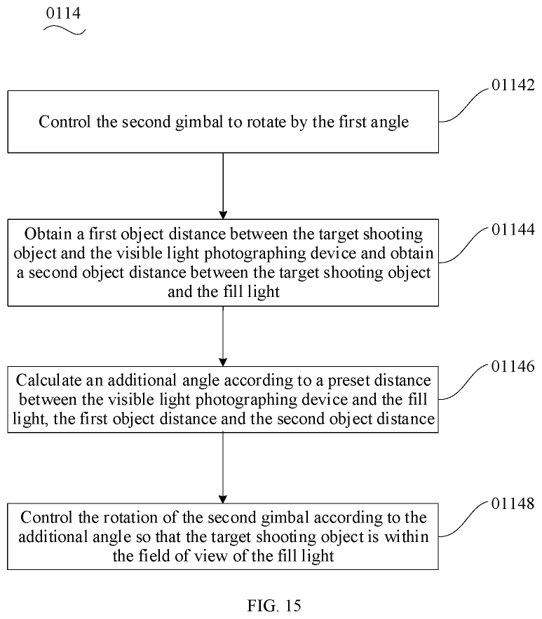

Referring to FIGS. 3, 14, and 15, in some embodiments, controlling the second gimbal 20 to rotate by the second angle F2 so that the target shooting object 2000 is at the center of the field of view of the fill light 42 (0114 in FIG. 12) includes controlling the second gimbal 20 to rotate by the first angle F1 (01142 in FIG. 15), obtaining the first object distance D1 between the target shooting object 2000 and the visible light photographing device 32, and the second object distance D2 between the target shooting object 2000 and the fill light 42 (01144 in FIG. 15), calculating the additional angle β according to the preset distance D between the visible light photographing device 32 and the fill light 42, the first object distance D1, and the second object distance D2 (01146 in FIG. 15), and controlling the rotation of the second gimbal 20 according to the additional angle β so that the target shooting object 2000 is within the field of view of the fill light 42 (01148 in FIG. 15).

In some embodiments, the gimbal system 100 further includes the distance sensor 60 for detecting the first object distance D1 between the target shooting object 2000 and the visible light photographing device 32, and detecting the second object distance D2 between the target shooting object 2000 and the fill light 42. The processor 52 is connected to the distance sensor 60 and reads the data in the distance sensor 60, that is, the processor 52 is configured to obtain the first object distance D1 between the target shooting object 2000 and the visible light photographing device 32 and obtain the second object distance D2 between the target shooting object 2000 and the fill light 42. The processor 52 is further configure to control the second gimbal 20 to rotate by the first angle F1, calculate the additional angle β according to the preset distance D between the visible light photographing device 32 and the fill light 42, the first object distance D1 and the second object distance D2, and control the rotation of the second gimbal 20 according to the additional angle β so that the target shooting object 2000 is within the field of view of the fill light 42. That is, the processes of 01142, 01144, 01146 and 01148 can be executed by the processor 52.

The distance sensor 60 may be provided at the control device 50 or may be provided independent of the control device 50. The distance sensor 60 may be a laser rangefinder or a binocular vision system as described above. In this way, the measurement accuracy is high, which is beneficial to precise focusing to improve the light fill effect. In one example, the second angle F2 is equal to the sum of the first angle F1 and the additional angle β. When the fill light 42 rotates by the second angle F2, that is, by an angle of F1+β, the target shooting object 2000 locates at the center of the field of view of the fill light 42, and the light on the target shooting object 2000 is the strongest and the light fill effect is good. In some embodiments, the gimbal system 100 is applied to the UAV 1000, that is, the visible light photographing device 32 and the fill light 42 are mounted at the UAV 1000 through the gimbal system 100. During the flight of the UAV 1000, at an initial state, the visible light photographing device 32 and the fill light 42 are usually directed forward, and the first gimbal 10 and the second gimbal 20 are at a zero position. After the user confirms the target shooting object 2000 through the remote control on the ground terminal and inputs a single control instruction including the first angle F1, the flight control device 300 receives the single control instruction and forwards it to the processor 52. According to the instruction, the processor 52 is configured to control the first gimbal 10 to rotate by the first angle F1 and control the second gimbal 20 to also rotate by the first angle F1, calculate the additional angle β according to the preset distance D, the first object distance D1 and the second object distance D2, and then control the second gimbal 20 to rotate by the additional angle β. The second angle F2 by which the second gimbal 20 rotates satisfies the following relationship F2=F1+β. In some other embodiments, after the additional angle β is calculated, the angle by which the processor 52 controls the second gimbal 20 to rotate may be smaller than the additional angle β or may be greater than the additional angle β, that is, the second angle F2 may also satisfy the following relationship F2>F1+β or F2<F1+β, as long as the field of view of the visible light photographing device 32 and the field of view of the fill light 42 at least partially overlap after the first gimbal 10 rotates by the first angle F1 and the second gimbal 20 rotates by the second angle F2.

When the second gimbal 20 is controlled to rotate by the first angle F1, two control instructions can also be received. One control instruction is used to control the first gimbal 10 to rotate by the first angle F1, and the other control instruction is used to control the second gimbal 20 synchronously to rotate by the first angle F1, and then, the second gimbal 20 can be automatically rotated by an additional angle so that the center of the field of view of the fill light 42 is close to or coincides with the center of the field of view of the visible light photographing device 32.

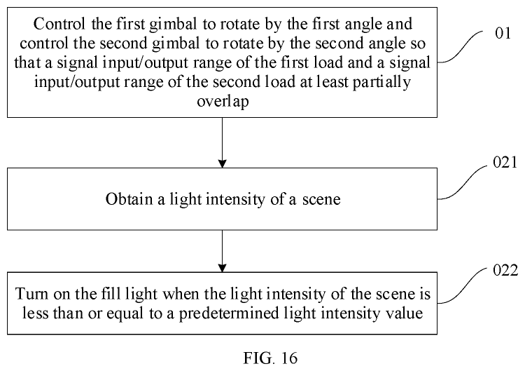

As shown in FIG. 16, in some embodiments, the control method further includes obtaining a light intensity of a scene (021) and turning on the fill light 42 when the light intensity of the scene is less than or equal to a predetermined light intensity value (022).

As shown in FIG. 3, in some embodiments, the gimbal system 100 further includes a light sensor 54. The light sensor 54 is used to detect the light intensity of the scene. The processor 52 is connected to the light sensor 54 and reads the data in the light sensor 54, that is, the processor 52 is configured to obtain the light intensity of the scene and turn on the fill light 42 when it detects that the light intensity of the scene is less than or equal to the predetermined light intensity value. That is, the processes of 021 and 022 can be executed by the processor 52. The light sensor 54 may be provided at the control device 50 (as shown in FIG. 3), or may be provided independent of the control device 50.

Further, in practical applications, when the light intensity of the scene is less than or equal to the predetermined light intensity value, the second gimbal 20 can also be automatically controlled to rotate by a certain angle, so that the field of view of the fill light 42 and the field of view of the visible light photographing device 32 at least partially overlap. In this way, the user's operation can be reduced, which is beneficial to intelligent use and can fill light for the visible light photographing device 32 in time.

The control device 50 may be a device independent of the movable platform, or may be provided at the movable platform as a part of the movable platform. For example, the aircraft 1000 is the movable platform. When the control device 50 is provided at the movable platform, the control device 50 may be the flight control device 300 or a device other than the flight control device 300. However, the control device 50 can communicate with the flight control device 300. For example, the flight control device 300 can transmit the control instructions received from the remote control on the ground terminal of the flight control device 300 for controlling the rotation of the first gimbal 10 and/or the second gimbal 20 to the control device 50, which is not limited here.

Further, after the field of view of the visible light photographing device 32 and the field of view of the fill light 42 are adjusted through the first gimbal 10 and the second gimbal 20 to at least partially overlap, if the visible light photographing device 32 zooms, the fill light 42 also zooms relative to the visible light photographing device 32, and even zooms synchronously with the visible light photographing device 32, so as to facilitate a complete coverage of the field of view of the fill light 42 on the field of view of the visible light photographing device 32 and the imaging of the visible light photographing device 32.

As shown in FIG. 2, the gimbal system 100 is also provided according to the present disclosure. The gimbal system 100 includes the first gimbal 10 and the second gimbal 20. The first gimbal 10 is used to support the first load 30 and the second gimbal 20 is used to support the second load 40. The gimbal system 100 includes the processor 52. The processor 52 is configured to control the first gimbal 10 to rotate by the first angle F1 and control the second gimbal 20 to rotate by the second angle F2, so that the signal input/output range of the first load 30 and the signal input/output range of the second load 40 at least partially overlap. The first gimbal 10, the second gimbal 20, the first load 30, and the fourth load 40 are described above and are not described again here. The structures and functions of the processor 52 of the gimbal system 100 and the processor 52 of the control device 50 are the same, which are not repeated here.

Further, as shown in FIG. 3, the gimbal system 100 further includes the distance sensor 60. The distance sensor 60 is described above and is not described again here. Further, as shown in FIG. 3, the gimbal system 100 further includes the light sensor 54, which is described above and is not described again here.

As shown in FIGS. 2 and 3, the UAV 1000 is further provided according to the present disclosure. The UAV 1000 includes the gimbal system 100, a body 200, and the flight control device 300 according to any one of the foregoing embodiments. The flight control device 300 is mounted at the body 200, and the gimbal system 100 is also mounted at the body.

A computer-readable storage medium is further provided according to the disclosure and includes a computer program used in combination with the above-mentioned UAV 1000, and the computer program can be executed by the processor 52 to implement a control method of any one of the above embodiments.

For example, the computer program may be executed by the processor 52 to control the first gimbal 10 to rotate by the first angle F1 and control the second gimbal 20 to rotate by the second angle F2, so that the signal input/output range of the first load 30 and the signal input/output range of the second load 40 at least partially overlap (i.e., the process at 01).

For another example, the computer program may also be executed by the processor 52 to control the first gimbal 10 to rotate by the first angle F1 and control the second gimbal 20 to rotate by the second angle F2, so that the field of view FOV1 of the visible light photographing device 32 and the field of view FOV2 of the fill light 42 at least partially overlap (i.e., the process at 011).

In the description of the disclosure, the descriptions referring to the terms “one embodiment,” “some embodiments,” “schematic embodiments,” “examples,” “specific examples,” or “some examples” mean that the specific features, structures, materials, or characteristics described in the embodiments or examples are included in at least one embodiment or example of the present disclosure. In this disclosure, the schematic expressions of the above terms do not necessarily refer to the same embodiment or example. Moreover, the specific features, structures, materials, or characteristics described may be combined in any suitable manner in any one or more embodiments or examples.

Any process or method description in a flowchart or otherwise described herein may be understood as a module, segment, or portion of code that includes one or more executable instructions for performing specific logical functions or steps of the process. The preferred embodiment of the present disclosure includes additional executions, where the functions may not be performed in the order shown or discussed, such as performing functions in a substantially simultaneous manner or in reverse order according to the functions involved, which should be understood by those skilled in the art.

The logic and/or steps represented in the flowchart or otherwise described herein, such as a sequenced list of executable instructions for performing logical functions, can be specifically executed in any computer-readable medium to be used by or in combination with an instruction execution system, a device, or an equipment (such as a computer-based system, a system including a processor, or other systems that can obtain and execute instructions from an instruction execution system, a device, or an equipment). In this disclosure, a “computer-readable medium” may be any device that can contain, store, communicate, or transmit a program for use by or in connection with an instruction execution system, a device, or an equipment. More specific examples of computer-readable media (non-exhaustive list) include electrical connections (electronic devices) with one or more wires, portable computer cartridges (magnetic devices), random-access memories (RAM), read-only memories (ROM), erasable and editable read-only memories (EPROM or flash memory), fiber optic devices, and portable compact disk read-only memories (CDROM). In addition, the computer-readable medium may even be paper or other suitable medium on which the program can be printed, because the program can be obtained electronically by optically scanning the paper or other medium and editing, interpreting, or other appropriate processing, and then can be stored in a computer memory.

Each part of the present disclosure may be implemented by hardware, software, firmware, or a combination thereof. In the above embodiments, multiple steps or methods may be performed using software or firmware stored in memory and executed by a suitable instruction execution system. For example, if it is executed by hardware, it can be executed by any one or a combination of the following techniques known in the art: a discrete logic circuit with a logic gate circuit for performing a logic function on a data signal, a dedicated integrated circuit with appropriate combinational logic gates, a programmable gate array (PGA), a field programmable gate array (FPGA), etc.

A person of ordinary skill in the art can understand that performing all or part of the steps carried by the above-described implementation method can be accomplished by a program instructing related hardware. The program can be stored in a computer-readable storage medium, and the program include one or a combination of the steps of the method when it is executed.

In addition, each functional unit in each embodiment of the present disclosure may be integrated into one processing module, or each unit may exist alone physically, or two or more units are integrated into one module. The above-mentioned integrated module may be executed in a form of hardware or software function module. If the integrated module is executed in the form of a software function module and sold or used as a stand-alone product, it may also be stored in a computer-readable storage medium.

The storage medium mentioned above may be a read-only memory, a magnetic disk or an optical disk. Although the embodiments of the present disclosure have been shown and described above, the above-mentioned embodiments are exemplary and should not be construed as limitations to the present disclosure. Those of ordinary skill in the art can make changes, modifications, substitutions, and variations to the above-described embodiments within the scope of the present disclosure.

What is claimed is:

1. A control method for controlling a gimbal system comprising:
controlling a first gimbal of the gimbal system to rotate by a first angle and controlling a second gimbal of the gimbal system to rotate by a second angle, so that a signal input/output range of a first load supported by the first gimbal and a signal input/output range of a second load supported by the second gimbal at least partially overlap.

2. The control method of claim 1, wherein:
the first load includes a visible light photographing device and the signal input/output range of the visible light photographing device is a field of view of the visible light photographing device; and
the second load includes a fill light and the signal input/output range of the fill light is a field of view of the fill light.

3. The control method of claim 2, wherein controlling the first gimbal to rotate by the first angle and controlling the second gimbal to rotate by the second angle so that the signal input/output range of a first load supported by the first gimbal and a signal input/output range of a second load supported by the second gimbal at least partially overlap includes:
controlling the first gimbal to rotate by the first angle and controlling the second gimbal to rotate by the second angle, so that the field of view of the visible light photographing device and the field of view of the fill light at least partially overlap.

4. The control method of claim 3, wherein controlling the first gimbal to rotate by the first angle and controlling the second gimbal to rotate by the second angle so that the field of view of the visible light photographing device and the field of view of the fill light at least partially overlap includes:
controlling the first gimbal to rotate by the first angle so that a target shooting object is within the field of view of the visible light photographing device; and
controlling the second gimbal to rotate by the second angle so that the target shooting object is within the field of view of the fill light.

5. The control method of claim 4, wherein:
controlling the first gimbal to rotate by the first angle so that the target shooting object is within the field of view of the visible light photographing device includes controlling the first gimbal to rotate by the first angle so that the target shooting object is at a center of the field of view of the visible light photographing device; and
controlling the second gimbal to rotate by the second angle so that the target shooting object is within the field of view of the fill light includes controlling the second gimbal to rotate by the second angle so that the target shooting object is at a center of the field of view of the fill light.

6. The control method of claim 4, further comprising:
obtaining a first object distance between the target shooting object and the visible light photographing device, and obtaining a second object distance between the target shooting object and the fill light;
calculating an additional angle according to a preset distance between the visible light photographing device and the fill light, the first object distance, and the second object distance; and
calculating the second angle according to the first angle and the additional angle.

7. The control method of claim 6, wherein the second angle is equal to a sum of the first angle and the additional angle.

8. The control method of claim 4, wherein controlling the second gimbal to rotate by the second angle so that the target shooting object is within the field of view of the fill light includes:
controlling the second gimbal to rotate by the first angle;
obtaining a first object distance between the target shooting object and the visible light photographing device, and obtaining a second object distance between the target shooting object and the fill light;
calculating an additional angle according to a preset distance between the visible light photographing device and the fill light, the first object distance, and the second object distance; and
controlling the second gimbal to rotate according to the additional angle so that the target shooting object is within the field of view of the fill light.

9. The control method of claim 3, wherein the field of view of the fill light covers the field of view of the visible light photographing device.

10. The control method of claim 3, wherein the first angle is same as the second angle.

11. The control method of claim 2, further comprising:
obtaining a light intensity of a scene; and
turning on the fill light in response to the light intensity of the scene being less than or equal to a predetermined light intensity value.

12. The control method of claim 11, wherein the fill light includes at least one of an infrared fill light or a visible light fill light.

13. The control method of claim 12,
wherein:
the visible light photographing device includes:
a switch; and
an infrared cut-off filter configured to filter infrared light; and
the fill light includes the infrared fill light;
the control method further comprising:
controlling the switch to remove the infrared cut-off filter from a light-receiving optical path of the visible light photographing device.

14. The control method of claim 1, wherein controlling the first gimbal to rotate by the first angle and controlling the second gimbal to rotate by the second angle are based on one or two control instructions.

15. The control method of claim 1, wherein:
both the first angle and the second angle are input; or
the first angle is input, and the second angle is calculated according to the first angle.

16. A control device comprising:
a processor configured to:
control a first gimbal of a gimbal system to rotate by a first angle and control a second gimbal of the gimbal system to rotate by a second angle, so that a signal input/output range of a first load supported by the first gimbal and a signal input/output range of a second load supported by the second gimbal at least partially overlap.

17. The control device of claim 16, wherein:
the first load includes a visible light photographing device and the signal input/output range of the visible light photographing device is a field of view of the visible light photographing device; and
the second load includes a fill light and the signal input/output range of the fill light is a field of view of the fill light.

18. The control device of claim 16, wherein the processor is configured to control the first gimbal to rotate by the first angle and control the second gimbal to rotate by the second angle based on one or two control instructions.

19. The control device of claim 16, wherein:
both the first angle and the second angle are input; or
the first angle is input, and the second angle is calculated according to the first angle.

20. A gimbal system comprising:
a first gimbal configured to support a first load;
a second gimbal configure to support a second load; and
a processor configured to:
control the first gimbal to rotate by a first angle and control the second gimbal to rotate by a second angle so that a signal input/output range of the first load and a signal input/output range of the second load at least partially overlap.
